(19) United States
(12) Patent Application Publication
(10) Pub. No.: US 2026/0032011 A1
(43) Pub. Date: Jan. 29, 2026

(54) Methods and Nodes in a Communications Network for Environmental Impact Determination

(71) Applicant: Telefonaktiebolaget LM Ericsson (publ), Stockholm (SE)

(72) Inventors: Hartmut Irnich, Hungen (DE); Walter Fieger, Egelsbach (DE); Ulrike Genz, Dietzenbach (DE); Gregory Liokumovich, Oberursel (DE)

(21) Appl. No.: 18/994,104

(22) PCT Filed: Jul. 19, 2022
(86) PCT No.: PCT/EP2022/070169

§ 371 Date: Jan. 14, 2025

(51) Int. Cl. H04L 12/14; H04M 15/00; H04W 4/24

(52) U.S. Cl. CPC H04L 12/1407; H04M 15/66; H04W 4/24

(57) ABSTRACT

A computer implemented method (1000) in a first node in a communications network comprises determining (1002) a first environmental impact caused by the first node due to the first node supporting a first Protocol Data Unit, PDU, session, and sending (1004) a first message to a second node wherein the first message comprises the determined first environmental impact.

### TECHNICAL FIELD

This disclosure relates to methods, nodes and systems in a communications network. More particularly but non-exclusively, the disclosure relates to determining an environmental impact caused by a PDU session in the communications network.

### BACKGROUND

Utilization of telecommunication services consumes energy and therefore has an environmental impact. According to some estimates, telecom operators account for 2-3 percent of the total global energy demand and this is likely to rise as smart phones and telecommunications infrastructure expands in emerging markets over the coming decade.

Energy consumption can be tracked by the energy supplier per real estate. For example, the owner/energy consumer is enabled to track the consumption of energy per device or per group of devices. This classic view of energy consumption is mainly motivated and driven by commercial considerations. From the supplier view, this enables the supplier to charge consumers for energy services; from the Consumer view, this gives fine-grained control of their energy consumption per device, and enables them to be able to reconcile the energy supplier's invoices.

The classic view aims towards a more “digitalized” solution supporting real-time tracking of energy consumption, time-dependent charging of the consumed energy and network-controlled consumption (e.g. such as utilization during off-peak times).

The environmental impact related to the energy consumption of single devices and how to determine the carbon footprint and emissions therefrom is described, for example, in US20180031533A1 entitled: “System and method for real-time carbon emissions calculation for electrical devices”; US20100030608A1 entitled “System and method for a carbon calculator including carbon offsets” and US20100070404A1 “Method and system for tracking and reporting emissions”.

### SUMMARY

Given the high energy consumption of the telecoms industry, and the environmental impact caused by it, there is a desire to reduce energy consumption, emissions, and thus the environmental impact of telecoms solutions.

Currently, energy usage reporting tools are available on a device-by-device level. This can be used, for example, by the device owner to apply cost-optimizations (e.g. replacing the CRT monitor by an TFT/LCD monitor).

However current energy usage reporting methods usually only provide a coarse-grained view per device and may only consider longer time-periods and summed impacts across different purposes, users and sessions.

As noted above, evaluating energy consumption and the related costs and carbon footprint is relevant in the telecommunication industry, as the telecom operators account for 2-3 percent of the total global energy demand; and energy costs contribute around 5-10% of telecoms operator's expenditure. It is an object of embodiments herein to improve upon some of the limitations described above.

Thus according to a first aspect there is a computer implemented method in a first node in a communications network. The method comprises determining a first environmental impact caused by the first node due to the first node supporting a first Protocol Data Unit, PDU, session and sending a first message to a second node wherein the first message comprises the determined first environmental impact.

According to a second aspect there is a computer implemented method performed by a second node in a communications network, the method comprising: receiving a first message from a first node in the communications network, the first message comprising a first environmental impact caused by the first node due to the first node supporting a first Protocol Data Unit (PDU) session; receiving a second message from a third node in the communications network, the second message comprising a second environmental impact caused by the third node due to the third node supporting the first PDU session; and sending a third message to a fourth node comprising an indication of an aggregated environmental impact of the first PDU session, wherein the aggregated environmental impact is based on the first environmental impact and the second environmental impact.

According to a third aspect there is a computer implemented method performed by a fourth node in a communications network, the method comprising: receiving a third message from a second node in the communications network, comprising an aggregated environmental impact of a plurality of nodes in the communications network supporting a first Protocol Data Unit (PDU) session.

According to a fourth aspect there is a method performed by a User Equipment, UE, in a communications network, the method comprising: initiating a first protocol data unit, PDU, session; and receiving a third message from a fourth node in the communications network, the third message comprising an indication of a first environmental impact of the first PDU session.

According to a fifth aspect there is a first node in a communications network, the first node comprising: a memory comprising instruction data representing a set of instructions; and a processor configured to communicate with the memory and to execute the set of instructions, wherein the set of instructions, when executed by the processor, cause the processor to: determine a first environmental impact caused by the first node due to the first node supporting a first Protocol Data Unit, PDU, session; and send a first message to a second node wherein the first message comprises the determined first environmental impact.

According to a sixth aspect there is a first node in a communications network, the first node being configured to perform the method of the first aspect.

According to a seventh aspect there is a second node in a communications network, the second node comprising: a memory comprising instruction data representing a set of instructions; and a processor configured to communicate with the memory and to execute the set of instructions, wherein the set of instructions, when executed by the processor, cause the processor to: receive a first message from a first node in the communications network, the first message comprising a first environmental impact caused by the first node due to the first node supporting a first Protocol Data Unit (PDU) session; receive a second message from a third node in the communications network, the second message comprising a second environmental impact caused by the third node due to the third node supporting the first PDU session; and send a third message to a fourth node comprising an indication of an aggregated environmental impact of the first PDU session, wherein the aggregated environmental impact is based on the first environmental impact and the second environmental impact.

According to an eight aspect there is a second node in a communications network, the second node being configured to perform the method of the second aspect.

According to a ninth aspect there is a fourth node in a communications network, the fourth node comprising: a memory comprising instruction data representing a set of instructions; and a processor configured to communicate with the memory and to execute the set of instructions, wherein the set of instructions, when executed by the processor, cause the processor to: receive a third message from a second node in the communications network, comprising an aggregated environmental impact of a plurality of nodes in the communications network supporting a first Protocol Data Unit (PDU) session.

According to a tenth aspect there is a fourth node in a communications network, the fourth node being configured to perform the method of the third aspect.

According to an eleventh aspect there is a User Equipment, UE in a communications network, the UE comprising: a memory comprising instruction data representing a set of instructions; and a processor configured to communicate with the memory and to execute the set of instructions, wherein the set of instructions, when executed by the processor, cause the processor to: initiate a first protocol data unit, PDU, session; and receive a third message from a fourth node in the communications network, the third message comprising an indication of a first environmental impact of the first PDU session.

According to a twelfth aspect there is a User Equipment, UE, the UE being configured to: initiate a first protocol data unit, PDU, session; and receive a third message from a fourth node in the communications network, the third message comprising an indication of a first environmental impact of the first PDU session.

According to a thirteenth aspect there is a computer program comprising instructions which, when executed on at least one processor, cause the at least one processor to carry out a method according to the first, second, third or fourth aspects.

According to a fourteenth aspect there is a computer program comprising instructions which, when executed on at least one processor, cause the at least one processor to: determine a first environmental impact caused by a first node due to the first node supporting a first Protocol Data Unit, PDU, session; and send a first message to a second node wherein the first message comprises the determined first environmental impact.

According to a fifteenth aspect there is a computer program comprising instructions which, when executed on at least one processor, cause the at least one processor to: receive a first message from a first node in the communications network, the first message comprising a first environmental impact caused by the first node due to the first node supporting a first Protocol Data Unit (PDU) session; receive a second message from a third node in the communications network, the second message comprising a second environmental impact caused by the third node due to the third node supporting the first PDU session; and send a third message to a fourth node comprising an indication of an aggregated environmental impact of the first PDU session, wherein the aggregated environmental impact is based on the first environmental impact and the second environmental impact.

According to a sixteenth aspect there is a carrier containing a computer program according to the thirteenth, fourteenth or fifteenth aspect wherein the carrier comprises one of an electronic signal, optical signal, radio signal or computer readable storage medium.

According to a seventeenth aspect there is a computer program product comprising non transitory computer readable media having stored thereon a computer program according to the sixteenth aspect.

Thus, in this way, the environmental impact of an individual PDU session can be determined, giving a fuller view of the total environmental impact associated with, for example, a particular streaming session, browsing session or any other usage of a user device. This provides support for an integrated end-to-end view per Protocol Data Unit (PDU) session, considering, for example, the Energy consumption by Communications Service Provider (CSP) infrastructure handling the session, Energy consumption by external providers handling the session and/or Energy consumption related to specific types of service and the user's consumption behaviour. Thus an E2E view is introduced to the end-consumer about the consumed energy of their PDU sessions considering different components supporting the used telecommunication services. This E2E view improves the awareness of the user regarding sustainability and also enables a different user-driven view to the operator to support improving the efficiency of the system.

### BRIEF DESCRIPTION OF THE DRAWINGS

For a better understanding and to show more clearly how embodiments herein may be carried into effect, reference will now be made, by way of example only, to the accompanying drawings, in which:

FIG. 1a shows a first node according to some embodiments herein;

FIG. 1b shows a method in a first node according to some embodiments herein;

FIG. 2a shows a second node according to some embodiments herein;

FIG. 2b shows a method in a second node according to some embodiments herein;

FIG. 3a shows a fourth node according to some embodiments herein;

FIG. 3b shows a method in a fourth node according to some embodiments herein;

FIG. 4a shows a user equipment according to some embodiments herein;

FIG. 4b shows a method in a user equipment according to some embodiments herein;

FIG. 5 shows nodes in a 5G network that may be involved in PDU session establishment according to some embodiments herein;

FIG. 6 illustrates a first node and energy consumption estimation thereof according to an embodiment herein;

FIG. 7 illustrates signals sent between the components illustrated in FIG. 6 according to an embodiment herein;

FIG. 8 illustrates nodes in a 5G network that may be involved in PDU session establishment and reporting according to some embodiments herein;

FIG. 9 illustrates a signal diagram between the nodes illustrated in FIG. 8 according to an embodiment; and

FIG. 10 illustrates a signal diagram between the nodes illustrated in FIG. 8 according to an embodiment.

### DETAILED DESCRIPTION

The disclosure herein relates to a communications network (or telecommunications network). A communications network may comprise any one, or any combination of: a wired link (e.g. Digital Subscriber Line, DSL) or a wireless link such as Global System for Mobile Communications (GSM), Wideband Code Division Multiple Access (WCDMA), Long Term Evolution (LTE), New Radio (NR), WiFi, Bluetooth or future wireless technologies. The skilled person will appreciate that these are merely examples and that the communications network may comprise other types of links. A wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, 5G, or future standards (such as 6G); wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

The disclosure herein relates to determining an environmental impact (e.g. energy expenditure or carbon footprint) associated with supporting a Protocol Data Unit (PDU) session. The disclosure herein proposes to calculate the environmental impact associated with individual PDU sessions, taking into account the environmental impact of different nodes associated with establishing and transferring data across the PDU session.

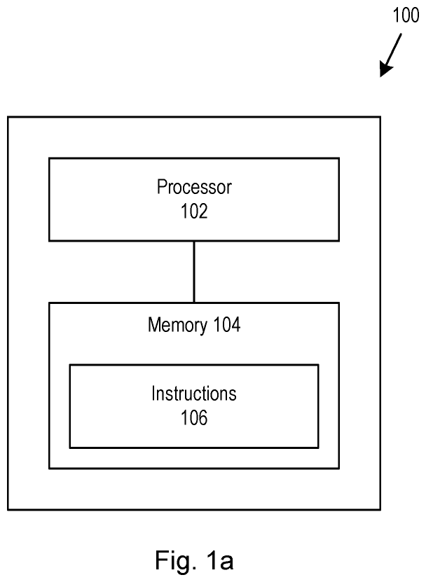

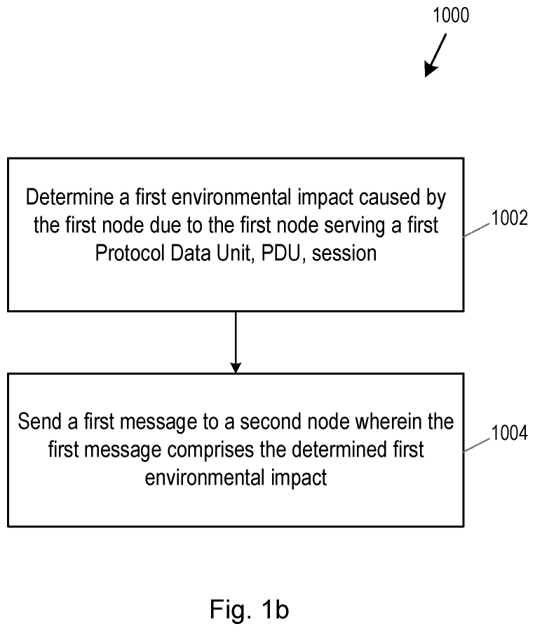

Turning now to FIG. 1a, which illustrates a first node 100 in a communications network according to some embodiments herein. Generally, the first node 100 may comprise any component or network function (e.g. any hardware or software module) in the communications network suitable for performing the functions described herein. For example, the first node may be any node in the communications network that is involved in the establishment of a PDU session. As another example, the first node may be any node in the communications network that is involved in supporting data across a PDU session.

The first node may comprise equipment capable, configured, arranged and/or operable to communicate directly or indirectly with a UE (such as a wireless device) and/or with other network nodes or equipment in the communications network to enable and/or provide wireless or wired access to the UE and/or to perform other functions (e.g., administration) in the communications network. Examples of nodes include, but are not limited to, access points (APs) (e.g., radio access points), base stations (BSs) (e.g., radio base stations, Node Bs, evolved Node Bs (eNBs) and NR NodeBs (gNBs)). In some embodiments, the first node is in the access network of a 5G network.

In some embodiments, the first node is a core network function such as, for example, a core network functions in a Fifth Generation Core network (5GC). For example, the first node may be a user plane function (UPF) in the Core network. In other embodiments herein, the first node is in the data network.

The skilled person will appreciate that these are merely examples, however, and that the first node may be any network node that has an environmental impact due to supporting the first PDU session, e.g. due to involvement in processes such as establishing, serving and/or transferring data using the first PDU session.

The first node 100 is configured (e.g. adapted, operative, or programmed) to perform any of the embodiments of the method 1000 as described below. It will be appreciated that the first node 100 may comprise one or more virtual machines running different software and/or processes. The first node 100 may therefore comprise one or more servers, switches and/or storage devices and/or may comprise cloud computing infrastructure or infrastructure configured to perform in a distributed manner, that runs the software and/or processes.

The first node 100 may comprise a processor (e.g. processing circuitry or logic) 102. The processor 102 may control the operation of the first node 100 in the manner described herein. The processor 102 can comprise one or more processors, processing units, multi-core processors or modules that are configured or programmed to control the first node 100 in the manner described herein. In particular implementations, the processor 102 can comprise a plurality of software and/or hardware modules that are each configured to perform, or are for performing, individual or multiple steps of the functionality of the first node 100 as described herein.

The first node 100 may comprise a memory 104. In some embodiments, the memory 104 of the first node 100 can be configured to store program code or instructions 106 that can be executed by the processor 102 of the first node 100 to perform the functionality described herein. Alternatively or in addition, the memory 104 of the first node 100, can be configured to store any requests, resources, information, data, signals, or similar that are described herein. The processor 102 of the first node 100 may be configured to control the memory 104 of the first node 100 to store any requests, resources, information, data, signals, or similar that are described herein.

It will be appreciated that the first node 100 may comprise other components in addition or alternatively to those indicated in FIG. 1a. For example, in some embodiments, the first node 100 may comprise a communications interface. The communications interface may be for use in communicating with other nodes in the communications network, (e.g. such as other physical or virtual nodes). For example, the communications interface may be configured to transmit to and/or receive from other nodes or network functions requests, resources, information, data, signals, or similar. The processor 102 of first node 100 may be configured to control such a communications interface to transmit to and/or receive from other nodes or network functions requests, resources, information, data, signals, or similar. Briefly, in one embodiment, the first node 100 is configured to determine a first environmental impact caused by the first node due to the first node supporting a first Protocol Data Unit, PDU, session, and send a first message to a second node wherein the first message comprises the determined first environmental impact.

In a 5G network, a “PDU Session” provides end-to-end user plane connectivity between the UE and a Data Network (DN) through the User Plane Function (UPF). One UE can have several PDU sessions established simultaneously. Each PDU Session supports one or more Quality of Service (QoS) flows representing a QoS profile. The user plane spans over an Access Network (AN), Core Network (CN) and Data Network (DN).

The first node may thus be involved in supporting a first PDU session. For example, the first node may be involved in creating or establishing the first PDU session and transferring Protocol Data Units such as user data for a particular service or application across the first PDU session (in other words within the first PDU session or in the context of the first PDU session).

The skilled person will be familiar with PDU session establishment which is described in the 3rd Generation Partnership Project (3GPP) Technical specification: TS 23.502.

It will be appreciated that more than one node in the communications network will generally be involved in establishing the first PDU session and/or transferring PDUs across the first PDU session. For example, a plurality of nodes may be involved in establishing and transferring PDUs across the first PDU session.

Furthermore, it will be appreciated that the first node may be involved in establishment of, and transfer of PDUs across, other PDU sessions (e.g. in addition to the first PDU session) and that the first node may be further configured to determine the environmental impact of the one or more other PDU sessions being supported by the first node. In other words, the first node may support more than one PDU session at a time. In some embodiments, the first node may determine an environmental impact for each PDU session being supported by the first node.

FIG. 1b shows a computer implemented method 1000 in a communications network according to some embodiments herein. The method 1000 may be performed by the first node 100 described above. In a first step 1002 the method 1000 comprises determining a first environmental impact caused by the first node due to the first node supporting a first Protocol Data Unit, PDU, session. In a second step 1004, the method 1000 comprises sending a first message to a second node wherein the first message comprises the determined first environmental impact.

The first environmental impact may be any estimation of the impact or cost to the environment of the first node supporting the first PDU session. The first environmental impact may be expressed as a value. The first environmental impact may be a measure of environmental impact or a parameter associated therewith. In some embodiments, the first environmental impact may be an estimation of energy consumption of the first node, emissions generated by the first node or a carbon footprint of the first node in supporting the first PDU session.

Energy consumption may be estimated based on electricity supplier data, for example, from electricity consumption data. Carbon footprint may be determined from e.g. electricity consumption data, using any appropriate conversion.

The environmental impact of the first node due to the first PDU session, may be determined (or estimated) in various different ways. For example, the total environmental impact of the first node may be determined and split between the different PDU sessions being supported by the first node.

In embodiments where the total environmental impact of the first node is determined, this may be performed, for example, based on Energy Consumption Records (ECR) for the node and/or supporting systems (such as e.g. cooling, systems, alarms systems, lighting systems associated with the first node). The energy consumption records may come from different energy consumers and providers. For example, different energy consumers (node, colling, alarm etc) can send their consumption in form of an ECR. and each of these ECRs can detail the source from which the consumed energy is received.

As an example, an Energy Consumption Record may be created for the first node. This may comprise fields such as:
startTime—beginning of the reporting time frame
endTime—end of the reporting time frame
deviceId—id of the device (e.g. node, sub system or supporting system thereof)
Energy consumption list
   Energy source type—(local, power line1, power line 2 etc)
   consumedEnergy—amount of energy from given source consumed during the time frame.

The total environmental impact of the first node may be split equally between the PDU sessions being served by the first node, or according to a weighting.

In some embodiments, the step of determining a first environmental impact caused by the first node due to the first node supporting the first PDU session comprises determining a total environmental impact of the first node and distributing the total environmental impact of the first node between the first PDU session and one or more other PDU sessions being supported by the first node. The step of distributing may be performed equally between the first PDU session and the one or more other PDU sessions; according to traffic volumes supported by the first PDU session and the one or more other PDU sessions; or according to any other another weighting mechanism that divides the environmental impact between the PDU sessions thereon.

In some embodiments, the total environmental impact of the first node may be split between PDU sessions being supported by the first node according Load Records (LR) for the first node. LR contains information about traffic supported during a timeframe (split per PDU sessions and QoS Profiles).

For example, a LR record may comprise the following attributes:
startTime—beginning of the reporting time frame
endTime—end of the reporting time frame
deviceId—id of the device (e.g. node, sub system or supporting system thereof)
Loads (list)
   PDU session ID
   QoS profile
   Traffic volume—amount of traffic served for given PDU session/QoS profile during the timeframe

As noted above, the first node may use a process to calculate energy impact for each PDU session that it supports (e.g. the method 1000 may be repeated by the first node for a plurality of PDU sessions). An example process for determining energy impact for each PDU session is to distribute consumed energy between all active sessions equally (e.g. with the same proportion).

Another example process for determining energy impact for each PDU session uses the following logic: Node energy consumption is measured in a “ready for traffic” mode, without supporting any UE. This energy consumption is called “base EC”. Then, for every PDU session energy consumption for the given time frame is calculated using following formula:

$$EC ( PDU session ) = \text{,,} base EC ” / AS + “ EC - base EC ” * PDU\_traffic / Total\_Traffic$$

### Where:

EC(PDU session)—Energy consumption associated with the PDU session (during the given time frame)
base EC—“base EC” of the node during the given time frame
AS—number of active PDU sessions during give time frame
EC—energy consumption of the node during the given time frame.
PDU_traffic_volume—served traffic related to the PDU session during the given time frame
Total_Traffic_volume—total served traffic during the given time frame

In other words, the energy usage/consumption associated with operating the first node (without any traffic) may be divided equally between all PDU sessions, and then energy usage/consumption over the baseline may be split between PDU sessions according to traffic load.

It is noted that these are merely examples and that energy consumption and environmental impact may be distributed between the PDU sessions being supported by the first node in other ways to those described above. For example, QoS may be taken into consideration.

In step 1004, as noted above, the method 1000 comprises sending a first message to a second node wherein the first message comprises the determined first environmental impact. The first message may be referred to as an Environmental Impact (EI) Message.

As an example, in some embodiments, the first message may comprise the following attributes:
deviceId (e.g. node, sub system or supporting system thereof; in EIR consumption from supporting devices like cooling is “incapsulated” into a network device consumption)
startTime—beginning of the reporting time frame
endTime—end of the reporting time frame

### Energy Consumption List

PDU session ID
QoS profile
consumption (list)
Energy source type—(local, power line1, power line 2 etc)
Consumed Energy—amount of energy from given source consumed during the time frame

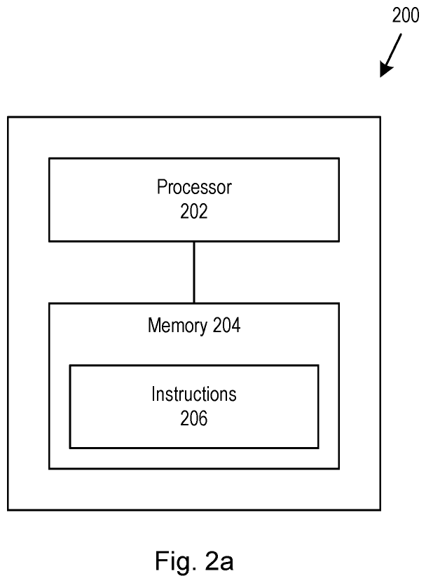

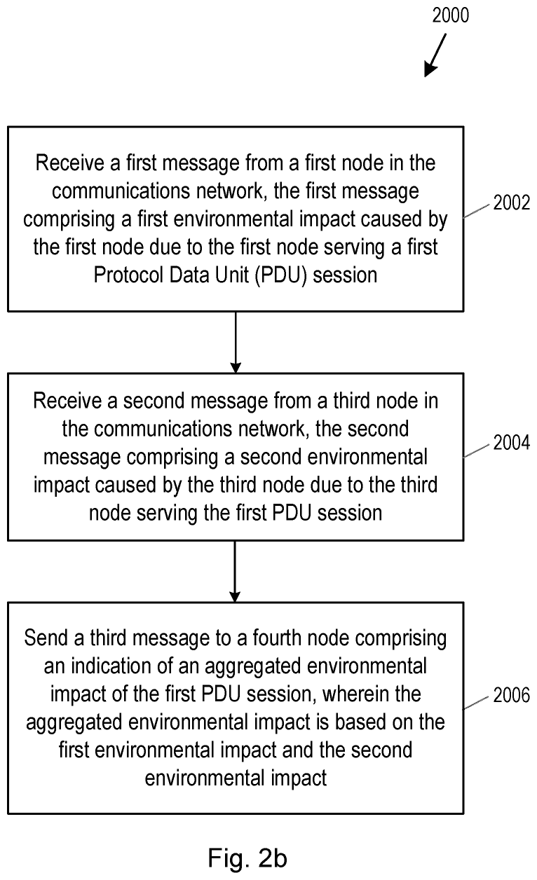

Turning now to FIG. 2a, which illustrates a second node 200 in a communications network according to some embodiments herein. Generally, the second node 200 may comprise any component or network function (e.g. any hardware or software module) in the communications network suitable for performing the functions described herein. For example, the second node may be any node in the communications network that is suitable for receiving messages related to the Environmental Impact of the PDU session and aggregating the Environmental Impacts in order to provide an aggregated (e.g. total) environmental impact related to two or more nodes involved in supporting the first PDU session.

Network nodes were described in detail above with respect to the first node, and the detail therein will be understood to apply equally to the second node.

In some embodiments, the second node is in the core network. For example, the second node may be a core network function such as, for example, a core network functions in a Fifth Generation Core network (5GC). The second node may be a Session Management Function, SMF.

The skilled person will appreciate that these are merely examples, however, and that the second node may be any network node that is capable of aggregating environmental impact measurements due to establishing and supporting the first PDU session.

The second node 200 may comprise a processor 202, and/or a memory 204. In some embodiments, the memory 204 of the second node 200 can be configured to store program code or instructions 206 that can be executed by the processor 202 of the second node 200 to perform the functionality described herein. Processors, memories and instructions were all described above with respect to the first node 100 and the detail therein will be understood to apply equally to the second node 200.

In some embodiments, the second node 200 is configured to receive a first message from a first node in the communications network, the first message comprising a first environmental impact caused by the first node due to the first node supporting a first Protocol Data Unit (PDU) session. The second node is further configured to receive a second message from a third node in the communications network, the second message comprising a second environmental impact caused by the third node due to the third node supporting the first PDU session, and send a third message to a fourth node comprising an indication of an aggregated environmental impact of the first PDU session, wherein the aggregated environmental impact is based on the first environmental impact and the second environmental impact.

In some embodiments, the second node 200 is configured (e.g. adapted or programmed) to perform the method 2000, illustrated in FIG. 2b. Briefly, the method 2000 comprises steps of: receiving 2002 a first message from a first node in the communications network, the first message comprising a first environmental impact caused by the first node due to the first node supporting a first Protocol Data Unit (PDU) session. In a second step the method 2000 further comprises receiving 2004 a second message from a third node in the communications network, the second message comprising a second environmental impact caused by the third node due to the third node supporting the first PDU session. In a third step the method 2000 comprises sending 2006 a third message to a fourth node comprising an indication of an aggregated environmental impact of the first PDU session, wherein the aggregated environmental impact is based on the first environmental impact and the second environmental impact.

Thus, in this way, the second node collects and aggregates environmental impact measures from first and third nodes involved in supporting a PDU session, in order to build up a combined (or total) environmental impact associated with the first PDU session.

The first message was described above with respect to the first node and the method 1000 and the detail therein will be understood to apply equally to embodiments of the second node and the method 2000.

In step 2004, the second node receives a second message from a third node comprising a second environmental impact determined by the third node in supporting the first PDU session.

The third node may be any of the types of node described above with respect to the first node. In other words, the third node may be any other node involved in establishing and/or supporting the first PDU session. The third node may be configured to perform the method 1000 described above in order to determine the second environmental impact. The second message may generally be in the same format as the first message.

In some embodiments, the second node further receives other messages from other nodes comprising other environmental impact measures associated with establishing and/or supporting the first PDU session. In some embodiments, the second node receives messages from all nodes involved in establishing and/or supporting the first PDU session, comprising environmental impact measures for each respective node.

Step 2006 may comprise aggregating the first environmental impact and the second environmental impact, and sending a third message to a fourth node, comprising the aggregated environmental impact for the first PDU session.

In some embodiments, the aggregated environmental impact may comprise a consolidated view (for the first PDU session) of the environmental impact involved in supporting the first PDU session. The aggregated environmental impact may ensure full traceability of the contributing nodes per session, for example, by listing each contributing node and the environmental impact thereof. Aggregating the first environmental impact and the second environmental impact may thus comprise consolidating the first environmental impact and the second environmental impact into a single data entry.

The aggregated environmental impact may be a summation of the first environmental impact and the second environmental impact. Aggregating the first environmental impact and the second environmental impact may thus comprise summing the first environmental impact and the second environmental impact into a single value. The single value may represent the combined or total environmental impact of the first PDU session. It will be appreciated however that other measures of aggregation may equally be used, for example, a mean, mode, range, or any other method of providing a combination of the first and second environmental impacts may equally be determined by the second node.

In embodiments where the second node receives other messages comprising other environmental impact measures, then the second node may add the other environmental impact measures into the aggregated environmental impact for the first PDU session. In embodiments where the second node receives messages from all nodes involved in establishing and/or supporting the first PDU session, comprising environmental impact measures for each respective node, then the aggregated environmental impact for the first PDU session may be an estimate of the total environmental impact associated with establishing and supporting the first PDU session.

In some embodiments, the step of sending a third message may be performed when the first PDU session is terminated. In other words, the second node may continue to aggregate the environmental impact measures for the first PDU session over time, until the first PDU session is terminated. The aggregated environmental impact for the first PDU session may thus be an estimate of the total environmental impact for the full duration of the first PDU session.

In some embodiments the third message may comprise an accumulated view on the key environmental measures representing the E2E session (This data provides an easy consumer view on the session based environmental impact).

The third message may further comprise a linked list of the detailed EI-Messages representing the E2E session and contributing to the Joined EI-Message (these data might be used for analysis to supply a more detailed consumer view as well as for the network feedback-loop).

As noted above, the third message is sent to a fourth node. In some embodiments, the fourth node is the UE for which the first PDU session was established. In this way, the aggregated environmental impact of a first PDU session established for the UE may be sent to the UE to enable the user thereof to monitor the environmental impact caused by different sessions. This may provide the user with a greater insights into their environmental impact (distinct from the environmental impact of the traditional measures associated with devices).

In other embodiments, the fourth node is a charging or billing system in the communications network. The charging or billing system may use such information for future planning and optimisation or management processes and/or may share a history of environment impact messages and its aggregated view with the consumer (e.g. on a monthly statement).

In embodiments, where the PDU session is established for a UE that is roaming, then the fourth node may be a charging or billing system in a home communications network of the UE.

In some embodiments, the fourth message initiates an adjustment to one or more network configuration parameters for a subsequent PDU session, based on the first environmental impact, in order to reduce a subsequent environmental impact of the subsequent PDU session, compared to the aggregated environmental impact. In other words the aggregated environmental impact for the first PDU session can be used as information with which to reduce the environmental impact of future PDU sessions. For example, the aggregated environmental impact may act as a reference for other PDU sessions, to identify areas where the environmental impact of the other PDU sessions could be reduced.

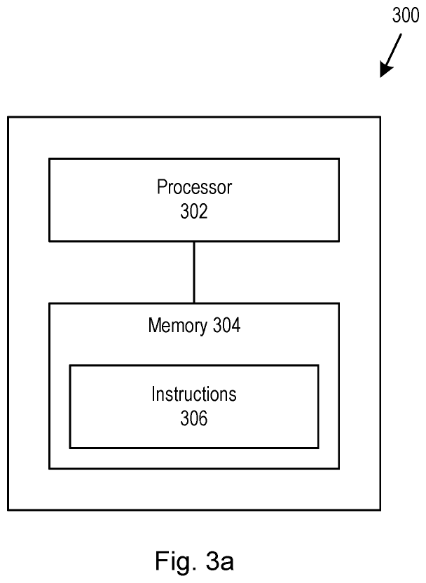

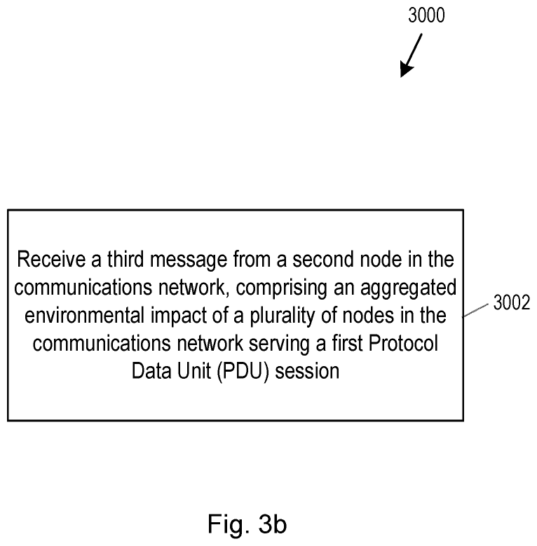

Turning now to FIG. 3a, which shows a fourth node 300 in a communications network according to some embodiments herein. Generally, the fourth node 300 may comprise any component or network function (e.g. any hardware or software module) in the communications network suitable for performing the functions described herein.

Network nodes were described in detail above with respect to the first node, and the detail therein will be understood to apply equally to the fourth node.

As an example, the fourth node may be in a 5G network. In some embodiments, the fourth node is part of a billing support system (BSS) or a Billing and Charging System.

The fourth node 300 may comprise a processor 302, and/or a memory 304. In some embodiments, the memory 304 of the fourth node 300 can be configured to store program code or instructions 306 that can be executed by the processor 302 of the fourth node 300 to perform the functionality described herein. Processors, memories and instructions were all described above with respect to the first node 100 and the detail therein will be understood to apply equally to the fourth node 300.

In some embodiments, the fourth node 300 is configured to receive a third message from a second node in the communications network, comprising an aggregated environmental impact of a plurality of nodes in the communications network supporting a first Protocol Data Unit (PDU) session.

The fourth node 300 may be configured to perform the method 3000 as illustrated in FIG. 3b. In brief, the method 3000 comprises receiving 3002 a third message from a second node in the communications network, comprising an aggregated environmental impact of a plurality of nodes in the communications network supporting a first Protocol Data Unit (PDU) session.

In some embodiments, the method 3000 may further comprise initiating an adjustment to one or more network configuration parameters for a subsequent PDU session, based on the aggregated environmental impact, in order to reduce a subsequent environmental impact of the subsequent PDU session, compared to the aggregated environmental impact.

Generally, the fourth node may gather and store the aggregated environmental impacts for a plurality of different PDU sessions and analyse them in order to determine ways to reduce the environmental impact of future PDU sessions.

The fourth node may further provide, or add the aggregated environmental information to charging and billing information for a User Equipment that the first PDU session was established for. This can enable the user of the user equipment to track their environmental impact on a PDU session basis (e.g. according to different types of activities performed by their devices.)

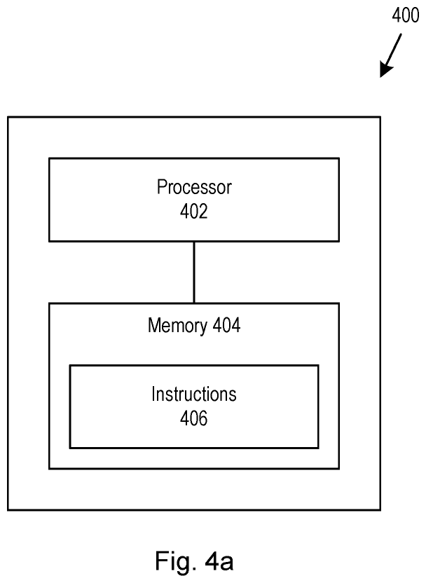

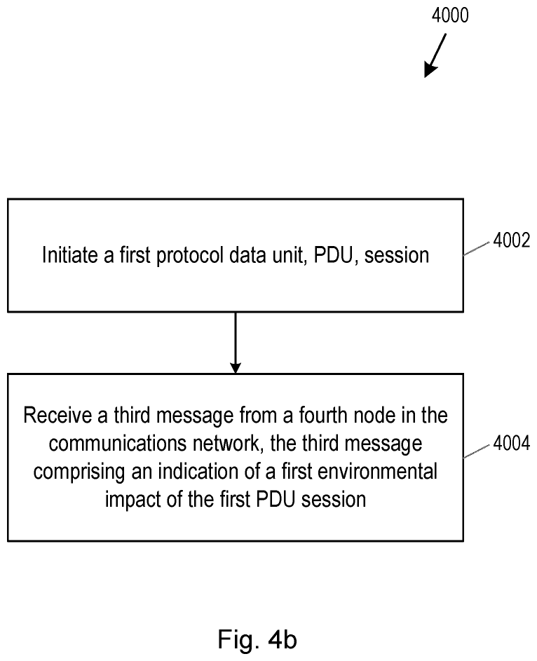

Turning now to FIG. 4a, which illustrates a user equipment 400 according to some embodiments herein. The first PDU session referred to herein is established for User equipment 400. For example, the first PDU session may be established in response to the User Equipment 400 accessing a service such as a streaming service, or any other service.

In more detail, the UE 400 may comprise a device capable, configured, arranged and/or operable to communicate wirelessly with network nodes and/or other wireless devices. Unless otherwise noted, the term UE may be used interchangeably herein with device, or wireless device (WD). Communicating wirelessly may involve transmitting and/or receiving wireless signals using electromagnetic waves, radio waves, infrared waves, and/or other types of signals suitable for conveying information through air. In some embodiments, a UE may be configured to transmit and/or receive information without direct human interaction. For instance, a UE may be designed to transmit information to a network on a predetermined schedule, when triggered by an internal or external event, or in response to requests from the network. Examples of a UE 400 include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. AUE may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a UE may represent a machine or other device that performs monitoring and/or measurements, and transmits the results of such monitoring and/or measurements to another UE and/or a network node. The UE may in this case be a machine-to-machine (M2M) device, which may in a 3GPP context be referred to as an MTC device. As one particular example, the UE may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a UE may represent a vehicle or other equipment that is capable of monitoring and/or reporting on its operational status or other functions associated with its operation. A UE 400 as described above may represent the endpoint of a wireless connection, in which case the device may be referred to as a wireless terminal. Furthermore, a UE as described above may be mobile, in which case it may also be referred to as a mobile device or a mobile terminal.

UE 400 may comprise a processor 402, a memory 404 and instructions 406. Processors, memories and instructions were all described above with respect to the first node 100 and the detail therein will be understood to apply equally to the UE 400.

It will be appreciated that the UE 400 may comprise other components in addition or alternatively to those indicated in FIG. 4a. For example, the UE 400 may comprise a communications interface. The communications interface may be for use in communicating with other UEs and/or nodes in the communications network, (e.g. such as other physical or virtual nodes such as the node 600 described above). For example, the communications interface may be configured to transmit to and/or receive from nodes or network functions requests, resources, information, data, signals, or similar. The processor 402 of UE 400 may be configured to control such a communications interface to transmit to and/or receive from nodes or network functions requests, resources, information, data, signals, or similar.

The UE 400 may be configured or operative to perform the methods and functions described herein, such as the method 4000 shown in FIG. 4b. The method 4000 comprises initiating 4002 a first protocol data unit, PDU, session, and receiving 4004 a third message from a fourth node in the communications network, the third message comprising an indication of a first environmental impact of the first PDU session. The first PDU session, third message and fourth nodes were all described above and the detail therein will be understood to apply equally to the method 4000.

Thus, in this manner, according to the methods and systems herein, a UE may be provided with an estimation of the environmental impact of individual PDU sessions (and thus individual activities initiated by a user on a UE). This gives the user greater transparency on the environmental impact such as energy expenditure associated with use of their devices.

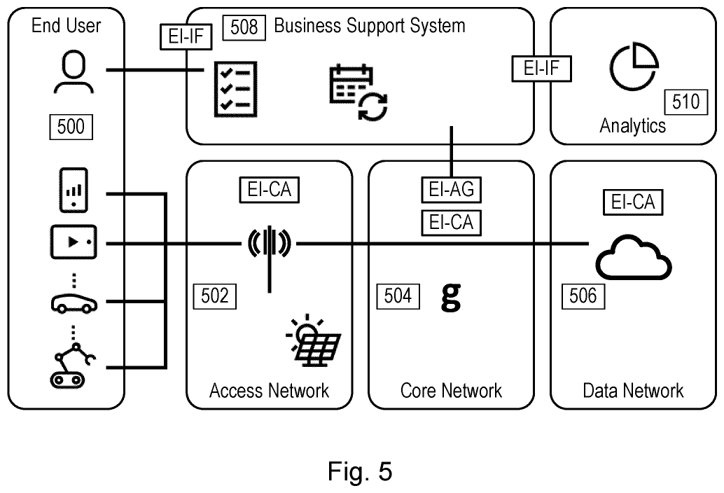

Turning now to other embodiments, FIG. 5 shows the different layers involved in consumer sessions in a 5G communications network, according to some embodiments. The End User layer 500 comprises different end user devices (such as, e.g. laptop, smartphone or car) of consumers that communicate with the Communication Service Provider's (CSP's) network. The devices connect via the Access Network layer 502. The access network 502, core network 504, and data network 506 may all be involved in are involved in PDU session establishment and data transfer related to the PDU session. A business support system (BSS) 508 may interact with the core network to perform billing and charging and performance monitoring and optimisation functions may be performed by analytics functions 510.

In the embodiment in FIG. 5, the first node may be in the access network 502, the third node may be in the data network 506 and the one or more other nodes may be, for example in the core network 504. The first node, the third node and the one or more other nodes may each comprise an Environmental Impact Calculator (EI-CA) that performs the method 1000 described above and calculates the environmental impact of the respective node due to the respective node supporting the first PDU session.

Technically, EI-CA can be implemented in different ways. For example, for a gNB it could be implemented as: a physical part of the gNB node implemented by the corresponding vendor; as a separate node, which is connected to the corresponding power lines and therefore be able to measures consumed energy; or as a software component which relies on measurements done by corresponding components themselves or by dedicated external sensors.

The second node may be a node in the core network 504 that is responsible for aggregating the environmental impacts of the first node, the third node and the one or more other nodes. The second node may comprise an Environmental Aggregator (EI-AG) that performs the method 2000 described above.

In more detail, in the embodiment illustrated in FIG. 5, the Access network 502 uses the EI-CA to calculate the consumed energy. The Core Network 504 supports the session in regard to different aspects. The Core Network 504 collects Energy consumption information associated with a first PDU session and stores the data in Environmental Impact Aggregator (EI-AG). Core Network 504 determines the environmental impact using/with help of an EI-CA for its own activities (that also performs the method 1000) and stores the determined impact accordingly (in EI-AG). Data Network 506 may be involved depending on the consumed services (Netflix, Instagram, Gaming, Cloud storage . . . ) Data Network 506 determines its impact using another EI-CA and transfers the information back to the Core Network 504.

The aggregated environmental impact information is forwarded from the Core Network node to the Business Support System (BSS) 508 for “long-term” persistence. For example, charging information might be enriched by the information about aggregated E2E consumed energy determined in Environmental Impact Aggregator (EI-AG). As an example, invoices could comprise e.g. environmental impact per service or consolidated environmental impact e.g. per month. EI-AG session-based information is collected, condensed and analyzed by the Environmental Analysis (Analytics) for further processing for the End-User. EI-AG session-based information might be used for the Core- and Data-Network analysis and provide feed-back to the network to optimize the network configuration.

With respect to the end-consumer 500, EI-AG information or information of different EI-AG instances from different PDU session for a specific customer can be supplied to the end consumer via an “Environmental Impact Interface” (EI-IF) to offer the near real-time information to the end-consumer (self-care or notification). Alternatively, or additionally, EI-AG information can be included in the End-Users recurring invoice or on a dedicated recurring statement.

It will be appreciated that FIG. 5 illustrates one embodiment of the methods herein as applied to a 5G network configuration. It will be appreciated that other configurations of nodes are also possible, and that the principles herein may equally be applied to other types of network to 5G networks.

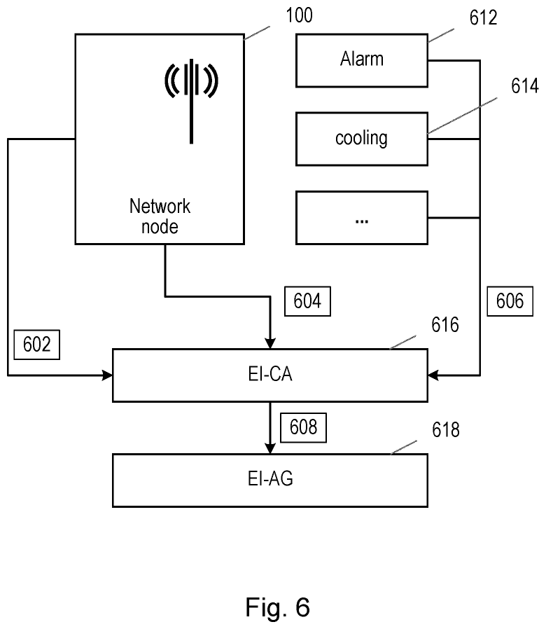

Turning now to FIG. 6, which illustrates another embodiment. In this embodiment the first node 100 is a base station. Base station 100 supports a first PDU session. In this embodiment, a first environmental impact associated with supporting the first PDU session is determined by EI-CA (which performs the method 1000) and this is sent to a second node EI-AG which performs the method 2000 and aggregates the first environmental impact of the first node with other environmental impact measures from other nodes in order to obtain aggregated data on the environmental impact of the first PDU session.

In this embodiment the environmental impact is measured in terms of energy usage of the first node and its associated components (e.g. alarm, 612, and cooling processes 614). Energy consumption of the first node 100 is sent to EI-CA in 602, along with network traffic data 604 and energy consumption of the associated components 612; 614 in message 606. EI-CA 616 sends a second message 608 to EI-AG comprising the aggregated environmental impact to EI-AG 618.

It is noted that although EI-CA is represented as a separate node in FIG. 6, that EI-CA may be part of the first node 100, may be separate from the first node 100 (e.g. located in a different node) or may be located in the cloud.

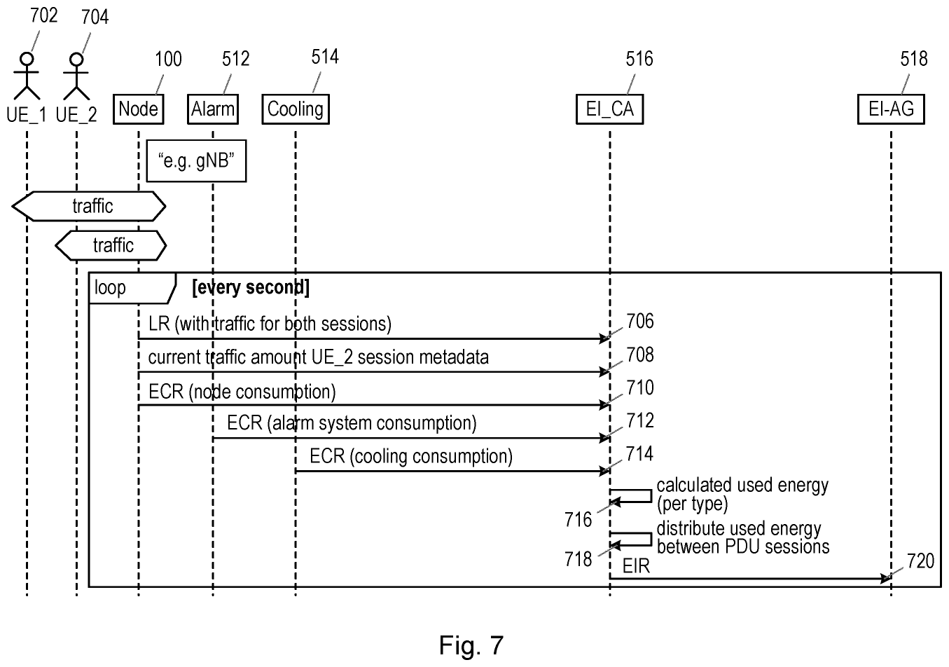

A signal diagram showing signals between the nodes in FIG. 6 is illustrated in FIG. 7 in an embodiment where two UEs, 702 and 704 have established first and second PDU sessions respectively. In this embodiment, the environmental impact is measured in terms of energy usage and EI-CA regularly receives Energy Consumption Records (ECR) from the network node and supporting systems (if used) via messages 710; 712 and 714. If multiple energy providers with different environmental impacts are used (for instance, energy produced by a locally mounted solar panels and received from the centralized system)—the information about the provider is also included in the message. Additionally, EI-CA receives Load Records (LR) from the network node in message 706 and current traffic amount in message 708 (note current traffic amounts for all PDU sessions supported by the first node 100 may be sent in message 708, if the first node is supporting more than one PDU session). LR contains information about traffic supported during a timeframe (split per PDU sessions and QoS Profiles). Using LR and ECR, EI-CA calculates energy impact for every supported PDU session in step 716 (in the same manner as step 1002 of the method 1000 above) and reports this to a second node (EI-AG 518) in the form of EI-Messages (EIR) 720 (in step 1004 of the method 1000 described above). EI-AG 518 then performs the method 2000 and determines an aggregation of all of the environmental impact measures.

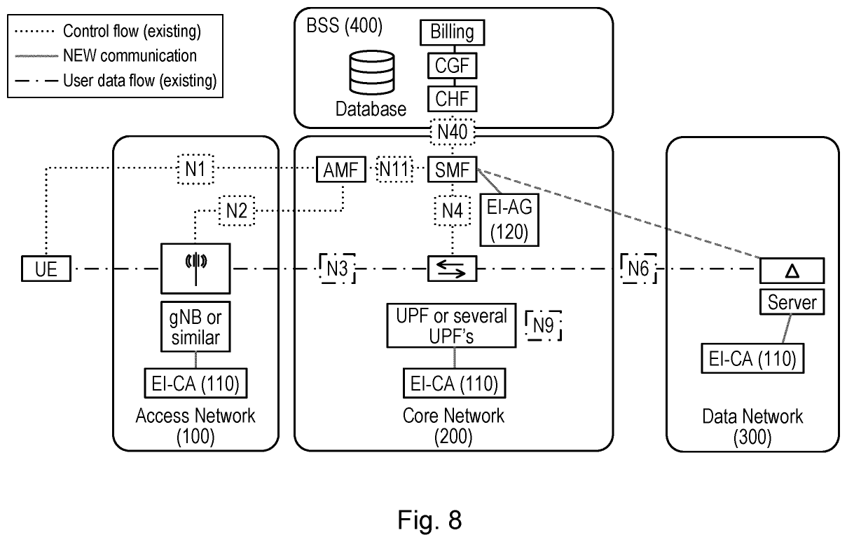

FIG. 8 illustrates another embodiment in a 5G network. In this embodiment, to report session-specific energy consumption, or environmental impact in the more general sense, EI-CA's are co-located with functions or nodes where measurable energy consumption is anticipated. Each EI-CA performs the method 1000 described above for its respective node. Here are examples:
Access Network (AN) contains gNB's. Each gNB is associated to a new EI-CA function which provides a measure for environmental impact for each PDU session which is handled by the node.
For non-3GPP access, EI-CA can be associated to N3IWF (Non-3GPP InterWorking Function) or TNGF (Trusted Non-3GPP Gateway Function) and more.
Core Network (CN) contains nodes offering User Plane Function (UPF). Each UPF can be associated to an EI-CA function.
Data Network (DN) contains servers which can be associated to an EI-CA function. If these servers are known to CN and have an awareness of PDU session, they can contribute.

Task of the EI-CA functions at different places is the same: each EI-CA performs the method 1000 described above for each PDU session running on its respective node and collects local data on environmental impact per PDU session. EI-CA functions do not need to know the subscriber or identifiers like MSISDN or IMSI of the subscriber. They may, for example, have access to the PDU session ID and QoS flow ID.
To make their data available and useable, several steps may be performed: Data from different EI-CA's for a particular PDU session (referred to herein as the first PDU session) may be collected at the second node that acts as a central location with respect to the first PDU session. In this embodiment, where the communications network is a 5G Core Network, (CN), the second node is the SMF (Session Management Function) for the first PDU session.
Data can be enriched with externally known subscriber identifiers. This can be SUPI (Subscription Permanent Identifier) including an IMSI, or Generic Public Subscription Identifier (GPSI) as for instance an MSISDN. Additional enrichment with parameters describing the used service supports the interpretation of data. SMF already performs corresponding tasks when preparing usage data for charging.
The enriched data may be communicated to a permanent storage place which can provide information to the consumer (or to the enterprise responsible for the UE). SMF can locate the appropriate Charging Function (CHF) and use its services. CHF is part of BSS. Charging Gateway Function or billing can store the data permanently and make it available for others. Therefore, the EI-AG function aggregating EI data from different EI-CA's can be located at SMF.

FIG. 8 summarizes the explanations above and places EI-CA and EI-AG into the 5G System Architecture in reference point representation. Note that only relevant components for this embodiment are illustrated in FIG. 8.

Reference points inside the User Plane are N3, N6 and N9. N9 is used between different UPF's which can be involved in the same PDU session. Detailed description of all components can be found in 3GPP TS 23.501 and references therein.

As explained above, EI-CA functions are associated with nodes and functions of the User Plane because the highest environmental impact is expected there.

Calculated EI data is transmitted from different EI-CA's to EI-AG, and afterwards to CHF. Instead of setting up direct sessions between EI-CA's and EI-AG's with considerable management overhead and the need to keep addresses for all EI-CA's and EI-AG's, the existing network structure including the Control Plane may be used. This assures that potential network reconfiguration by adding or removing nodes and functions is transparent to EI-CA and to EI-AG. EI-CA does not need to know which EI-AG is responsible for a PDU session, or how to find it because it is co-located with nodes and functions which have this knowledge. This is detailed below.

### From EI-CA in Core Network Associated to UPF to EI-AG

N4 session management procedures between SMF and UPF are described in 3GPP TS 23.502. Events related to an N4 session for an individual PDU Session including Usage Report is already communicated from UPF to SMF. This can form the basis for communication of EI data between UPF and SMF.

PDU session data generated on EI-CA function is passed to UPF. UPF sends EI data to SMF. This may be performed using an enhancement of N4 Session level Reporting Procedure. SMF passes the data to the associated EI-AG function for intermediate storage and aggregation.

### From EI-CA in Access Network to EI-AG

The path between AN to SMF via AMF (Access Management Function) using N2 and N11 is already established to exchange PDU session related data between AN and SMF. N2 messages from AN to AMF related to a PDU session are supported. The message can include SM information which AMF forwards to the appropriate SMF which manages the PDU session.

PDU session data generated on EI-CA function is passed to gNB (or equivalent node) on AN. AN includes it in a message for SMF which is forwarded by AMF to the appropriate SMF managing the PDU session. SMF passes the data to EI-AG for intermediate storage.

### From EI-CA in Data Network to EI-AG

A direct communication between SMF and a known server inside a data network can be set up via UPF using L2TP (Layer Two Tunnel Protocol).

Calculation of energy consumption in Data network is optional and depends on consumed services and if the data network servers belong to operator or external.

EI-CA communicates PDU session data to server on DN, and the server forwards the data as a message to SMF. Finally, SMF forwards to EI-AG.

Aggregation of data from different EI-CA's to EI-AG can happen multiple times during the lifetime of the PDU session.

### From EI-AG to BSS

SMF can find a Charging Function (CHF) which is able to handle the subscriber data. Using N40 reference point, it can use services offered by CHF, request units for consumption, or request to charge for used units. SMF provides information about user consumption to CHF. Using Charging Gateway Function (CGF), rated usage data can be prepared for permanent storage and/or for billing.

Charging and Billing systems typically offer a customer self-care interface which allows to investigate usage details. Invoices created by billing can include itemized usage data including details.

During and/or while releasing the PDU session, SMF can obtain aggregated environmental impact data from EI-AG. SMF enriches the data with subscriber and session information before communicating the data via SBI (Service Based Interface) to CHF. CHF which is integrated with Charging Gateway Function (CGF) and Billing Function allowing permanent storage of EI data.

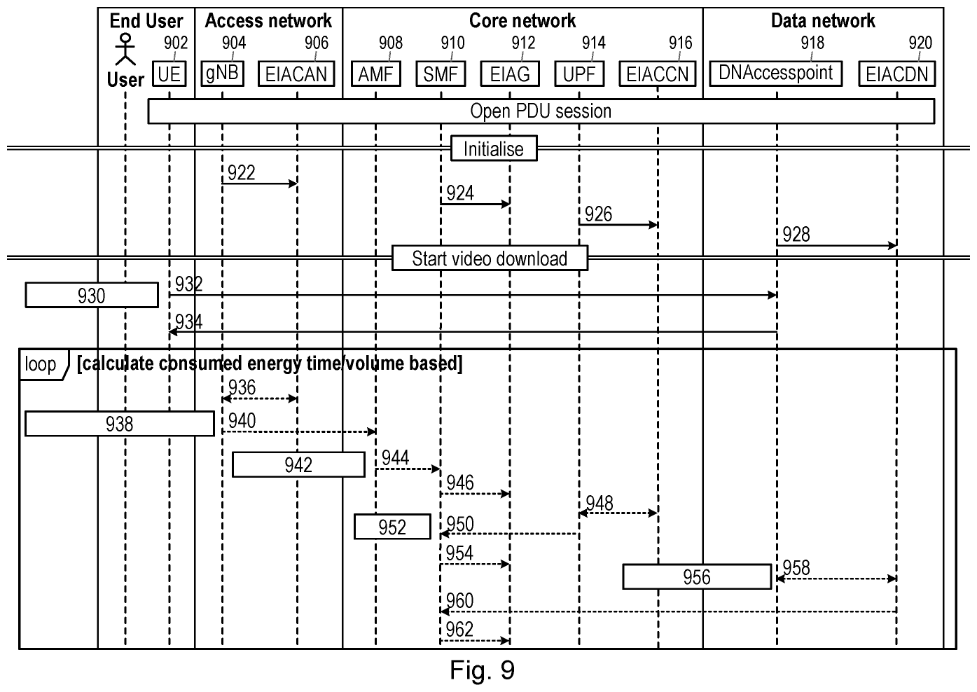

FIG. 9 illustrates a signal diagram for the flow above. In this embodiment, there is an end user operating a UE 902. A first PDU session is established for the UE 902. A first node gNB 904 is involved in establishing the first PDU session in the Access network, and a third node UPF 914 is involved in establishing the first PDU session in the core network. Another node DNAccesspoint 918 is involved in establishing the first PDU session in the Data network. A second node, SMF 910 in the core network is responsible for aggregating the environmental impact of the first node, the third node and the other node in order to determine an aggregated environmental impact for the first PDU session.

In this embodiment, the first (new) PDU session is opened (in the normal manner) and initialised, then the following steps are performed:
922: Initialise EI-CA to determine a first environmental impact of gNB 904
924: Initialise EI-AG to determine the aggregated environmental impact for the new PDU session
926 Initialise EI-CA to determine a second environmental impact of UPF 914 due to supporting the first PDU session
928 Initialise EI-CA to determine another environmental impact of DNAccesspoint 918 due to supporting the first PDU session

A video download is then started.
930: request video download via PDU session
932: Video download within the open PDU session and context
934: transfer data packets via PDU session
936: request is made to calculate the consumed energy in the access network time/volume for the open session
938: Use protocol N2 (e.g. an extended version thereof) to transfer calculated consumed time/volume based energy together with traffic
940: transfer calculated consumed energy together with traffic request
942: Use protocol N11 (e.g. an extended version thereof) to transfer calculated consumed time/volume based energy together with traffic
944: transfer calculated consumed energy together with traffic request
946: send transferred consumed energy to aggregator
948: request to calculate consumed energy in Core network time/volume based for first PDU session
950: transfer calculated consumed energy together with traffic request
952: Use protocol N4 (e.g. an extended version thereof) to transfer calculated consumed time/volume based energy together with traffic
954: send transferred consumed energy to aggregator
956: Use protocol L2TP (e.g. an extended version thereof) to transfer calculated consumed energy together with traffic
958: request to calculate consumed energy in Access network time/volume based for open session
960: transfer calculated consumed energy together with traffic response
962: send transferred consumed energy to aggregator

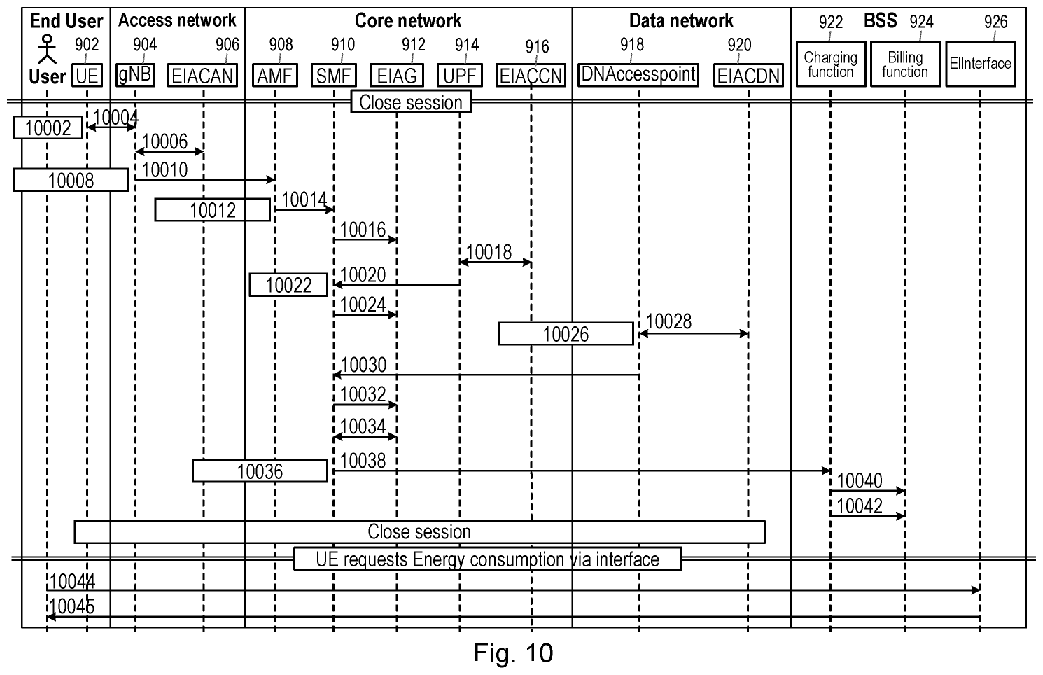

Turning now to FIG. 10 which shows a signal diagram when the first PDU session is closed/released. The consumed energy since the last calculation (e.g. the loop in the flow diagram of FIG. 9 described above) is calculated and passed to the billing function as follows:
10002: the first PDU session is triggered to close, this could be e.g. due to time-out.
10004: trigger close/release of first PDU session
10006: request to calculate consumed energy in Access network due to the first PDU session (EIACAN performs method 1000 described above)
10008: Use protocol N2 (e.g. an extended version thereof) to transfer calculated consumed time/volume based energy together with traffic
10010 transfer calculate consumed energy together with traffic request
10012: Use protocol N11 (e.g. an extension of the N11 protocol) to transfer calculated consumed time/volume based energy together with traffic
10014: transfer calculated consumed traffic together with traffic request (e.g. according to step 1004 of the method 1000 above)
10016: send transferred consumed energy to aggregator
10018: request to calculate consumed energy in Core Network time/volume based for first PDU session
10020: transfer calculated consumed energy together with traffic request
10022: Use N4 protocol (e.g. an extension of the N4 protocol) to transfer calculated consumed time/volume based energy together with traffic
10024: send transferred consumed energy to aggregator
10026: Use protocol L2TP to transfer calculated consumed energy together with traffic
10028: request to calculate consumed energy in Access network time/volume based for open session
10030: transfer calculated consumed energy together with traffic response
10032: send transferred consumed energy to aggregator
10034: request aggregated E2E consumed energy for the session
10036: for charging and billing purposes, the session-based information is forwarded to the OSS/BSS layer. OSS/BSS persists session-based consumer energy
10038: forward session-based consumed energy
10040: forward charged session information for invoice generation
10042: charges session information enriched by session-based consumed energy

The PDU session is then closed

Upon a request from the UE for the Energy consumption, e.g. via an interface:
10044: request consumed energy for specific time frame/service via user-interface/service
10046: consumed energy response

It will be appreciated that the signal diagrams above are merely examples and that the functionality described therein may equally be performed by other nodes or other combinations of nodes to those illustrated.

Turning now to embodiments where the UE is roaming, in roaming scenarios the following applies:
For roaming, 3GPP TS 23.501 differentiates between
   “Local Break Out” (LBO)
   “Home Routed” (HR)

For LBO, the SMF and all UPF(s) involved by the PDU Session are under control of the Visited Public Land Mobile Network (VPLMN), e.g. the network where subscriber is temporarily located, while subscriber charging happens in the Home Public Land Mobile Network (HPLMN), e.g. the network providing the subscription to the user. The procedure as described above can be used, but the consumer belonging to a different network cannot access the information directly. Still, VPLMN can extract the information for the HPLMN of the subscriber.

For HR, the PDU Session is supported by a SMF function under control of the HPLMN, by a SMF function under control of the VPLMN, by at least one UPF under control of the HPLMN and by at least one UPF under control of the VPLMN. In this case the SMF in HPLMN selects the UPF(s) in the HPLMN and the SMF in VPLMN selects the UPF(s) in the VPLMN. This means that the subscriber may get partial data from EI-CAs and EI-A belonging to HPLMN.

The methods and nodes described above provide an End2End Traffic view, that covers the environmental impact related to CSP's own and external infrastructure. It allows a fast (up to near-real time) feedback loop to the end customer describing the environmental impact of their consumption behavior. It may help in network optimization as the detailed session-based information collected per consumer, session, node might be used to identify optimization options within the network. The solutions herein may further enable and motivate innovative environmental protection initiatives by promoting eco-friendly technologies (e.g. “edge” computing), and/or promoting environmentally friendly tariffs.

In another embodiment, there is provided a computer program product comprising a computer readable medium, the computer readable medium having computer readable code embodied therein, the computer readable code being configured such that, on execution by a suitable computer or processor, the computer or processor is caused to perform the method or methods described herein.

For example, the functionality of the EI-CA described above may be performed by the first node, by a sub-component of the first node or by a stand-along computer program operating in a different node in the communications network.

As such, in some embodiments there is a computer program comprising instructions which, when executed on at least one processor, cause the at least one processor to determine a first environmental impact caused by a first node due to the first node supporting a first Protocol Data Unit, PDU, session and send a first message to a second node wherein the first message comprises the determined first environmental impact.

As another example, the functionality of the EI-AG described above may be performed by the second node, by a sub-component of the second node or by a stand-along computer program operating in a different node in the communications network.

As such, in some embodiments, there is a computer program comprising instructions which, when executed on at least one processor, cause the at least one processor to: receive a first message from a first node in the communications network, the first message comprising a first environmental impact caused by the first node due to the first node supporting a first Protocol Data Unit (PDU) session; receive a second message from a third node in the communications network, the second message comprising a second environmental impact caused by the third node due to the third node supporting the first PDU session; and send a third message to a fourth node comprising an indication of an aggregated environmental impact of the first PDU session, wherein the aggregated environmental impact is based on the first environmental impact and the second environmental impact.

Thus, it will be appreciated that the disclosure also applies to computer programs, particularly computer programs on or in a carrier, adapted to put embodiments into practice. The program may be in the form of a source code, an object code, a code intermediate source and an object code such as in a partially compiled form, or in any other form suitable for use in the implementation of the method according to the embodiments described herein.

It will also be appreciated that such a program may have many different architectural designs. For example, a program code implementing the functionality of the method or system may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other.

The carrier of a computer program may be any entity or device capable of carrying the program. For example, the carrier may include a data storage, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1-31. (canceled)

32. A computer implemented method performed by a first node in a communications network, the method comprising:
determining a first environmental impact caused by the first node due to the first node supporting a first Protocol Data Unit, PDU, session; and
sending a first message to a second node wherein the first message comprises the determined first environmental impact.

33. The method as in claim 32, wherein the first environmental impact is an estimation of an energy consumption or a carbon footprint of the first node in supporting the first PDU session.

34. The method as in claim 32, wherein the step of determining a first environmental impact caused by the first node due to the first node supporting the first PDU session comprises:
determining a total environmental impact of the first node; and
distributing the total environmental impact of the first node between the first PDU session and one or more other PDU sessions being supported by the first node.

35. The method as in claim 34, wherein the step of distributing is performed:
equally between the first PDU session and the one or more other PDU sessions; or
according to traffic volumes supported by the first PDU session and the one or more other PDU sessions.

36. A computer implemented method performed by a second node in a communications network, the method comprising:
receiving a first message from a first node in the communications network, the first message comprising a first environmental impact caused by the first node due to the first node supporting a first Protocol Data Unit (PDU) session;
receiving a second message from a third node in the communications network, the second message comprising a second environmental impact caused by the third node due to the third node supporting the first PDU session; and
sending a third message to a fourth node comprising an indication of an aggregated environmental impact of the first PDU session, wherein the aggregated environmental impact is based on the first environmental impact and the second environmental impact.

37. The method as in claim 36, wherein the step of sending a third message is performed when the first PDU session is terminated.

38. The method as in claim 36, wherein the fourth node is:
a UE that the first PDU session was established for; or
a charging or billing system in the communications network.

39. The method as in claim 36, further comprising:
initiating an adjustment to one or more network configuration parameters for a subsequent PDU session, based on the first environmental impact, in order to reduce a subsequent environmental impact of the subsequent PDU session, compared to the aggregated environmental impact.

40. The method as in claim 36, wherein the first PDU session is for a UE that is roaming in the communications network; and wherein the fourth node is a charging or billing system in a home communications network of the UE.

41. The method as in claim 36, wherein the first node is:
in the access network of the communications network;
in the data network;
a session management function, SMF;
access management function, AMF in the core network;
a user plane function, UPF, in the core network; or
a gNodeB or an eNodeB.

42. The method as in claim 36, wherein the second node is a core network node in the communications network.

43. A computer implemented method performed by a fourth node in a communications network, the method comprising:
receiving a third message from a second node in the communications network, comprising an aggregated environmental impact of a plurality of nodes in the communications network supporting a first Protocol Data Unit (PDU) session.

44. The method as in claim 43, further comprising:
initiating an adjustment to one or more network configuration parameters for a subsequent PDU session, based on the aggregated environmental impact, in order to reduce a subsequent environmental impact of the subsequent PDU session, compared to the aggregated environmental impact.

45. The method as in claim 44, further comprising:
providing the aggregated environmental impact to charging or billing information for a User Equipment that the first PDU session was established for.
